(19) United States
(12) Patent Application Publication
(10) Pub. No.: US 2013/0190152 A1
(43) Pub. Date: Jul. 25, 2013

(54) MULTISPINDLE MACHINING CENTER

(71) Applicant: CHIN-LUNG KAO, Taichung City (TW)

(72) Inventor: CHIN-LUNG KAO, Taichung City (TW)

(73) Assignee: KOVA CARBIDE TOOLS CO., LTD.

(21) Appl. No.: 13/568,664

(22) Filed: Aug. 7, 2012

(30) Foreign Application Priority Data
Jan. 20, 2012 (TW) 101102426

(51) Int. Cl. B23Q 3/157

(52) U.S. Cl. 483/30

(57) ABSTRACT

A multispindle machining center includes a machine body, a knife rack, and a plurality of spindles. The knife rack has a knife rack body, a plurality of knife claws and a plurality of knife holders. The knife rack body has a plurality of accommodating troughs and accommodating trough openings connecting the accommodating troughs to the outside. The knife claw has a knife claw trough penetrating the top and bottom of the knife claw, and the knife claw opening connects the knife claw trough to the outside. The knife holder has a spindle connecting end and knife connecting end. The size and shape of the spindle connecting end is the same, while the size and shape of the knife connecting end vary. The outer periphery of the knife holder has a clipping portion which can be forced into the knife claw trough from the knife claw opening in a detachable way.

### BACKGROUND

1. Technical Field

The present invention relates to a multispindle machining center, particularly a knife rack of the multispindle machining center.

2. Related Art

Since the multispindle machining center can do the processing work with multiple spindles, it can save time and efforts and has a good working efficiency when working on complicated shape of a work piece or large amount of work pieces. Because the multispindle machining center has a plurality of spindles, all the spindles should be able to be replaced varieties of knives with different types and sizes. If the knife replacement is done manually, it will waste a lot of time and labor. Therefore, the multispindle machining center will equipped with a knife magazine or a knife rack which can accommodate varieties of knives with different size (such as turning tool, milling cutter, drill bit, tapping knife, hole boring cutter, etc.). The main difference of the knife magazine and the knife rack is, the knife magazine can change the knife on the spindle automatically, which means the spindle is in a passive condition, and the knife magazine should be equipped with a driving mechanism. However, the size of the knife magazine will be larger than normal ones, and the structure of the knife magazine will be more complicated, which results in high cost of the equipment as well. On the contrary, the knife rack is in a passive condition when changing the knife on the spindle, which means the spindle needs to move to the knife rack actively to change the knife, and the knife rack does not need to be equipped with a driving mechanism, thereby minimizing the volume and simplifying the structure, and the cost is lower as well.

Since the knife rack matches up the spindle passively, and the size of the spindle is restricted, which means the spindle can only clip or hold the knife with specific size of handle. Therefore, the conventional multispindle machining center and the knife rack can only provide the knife with single size, and the handle size of all the knives on the rack should also be the same. Thus, the standard variation of the knife is very limited, which results that the conventional multispindle machining center can not use all kinds of knives when doing the processing work on the same work piece. The conventional multispindle machining center can only do the single shape processing works with the knife of specific type and size in the same time. Thus, it is necessary to find a new way to solve this problem.

### BRIEF SUMMARY

The present invention relates to a multispindle machining center with a knife rack having knife of different shape and size.

The present invention also relates to a multispindle machining center being able to do the multi function processing.

Accordingly, a multispindle machining center of the present invention includes a machine body, a plurality of spindles equipped on the machine body, and a knife rack arranged on the machine body. The knife rack includes a knife rack body having at least one row of accommodating trough, the row of the accommodating trough having a plurality of accommodating troughs and a plurality of accommodating trough openings connecting the accommodating trough to the outside; a plurality of knife claws arranged on the knife rack, the knife claw having a knife claw trough penetrating the top and the bottom of the knife claw, and a knife claw opening connecting the knife claw trough to the outside; every knife claw trough of the knife claw being corresponding to each accommodating trough of the knife rack body, and each knife claw opening of the knife claw being corresponding to each accommodating trough opening of the knife rack body; and a plurality of knife holder having a spindle connecting end and a knife connecting end on both terminals, respectively; the size and shape of the spindle connecting end of each holder being the same, and the knife connecting end of each knife holder having the same or different size and shape; each knife holder having a clipping portion on the outer periphery, and each clipping portion of the knife holder being forced into the knife claw trough from the knife claw opening in a detachable way.

In one preferred embodiment, the row of the accommodating trough of the knife rack body has at least one set of accommodating trough, and each set of the accommodating trough has accommodating trough and accommodating trough openings connecting the accommodating troughs to the outside corresponding to the amounts of the spindles.

In one preferred embodiment, each knife claw is in a U shape and is flexible, the knife connecting end of each knife holder is able to clip the knife with different shape and size, and the outer periphery of the clipping portion is smaller than the inner periphery of the knife claw trough of the knife claw, and the outer periphery of the clipping portion is larger than the inner periphery of the knife claw opening of the knife claw.

In one preferred embodiment, the knife rack further includes a protection shield located outside of the knife rack body, the protection shield can do a linear reciprocating movement between an open position and a closed position; when the protection shield is in the open position, all the knife claws, knife holders, and the knives connected to the knife holders that arranged on the knife rack body are exposed outside the protection shield; when the protection shield is in the closed position, all the knife claws, knife holders, and the knives connected to the knife holders that arranged on the knife rack body are covered inside the protection shield.

In one preferred embodiment, both opposite sides of the knife rack body have a first track respectively, and the both opposite sides of the protection shield have a second track respectively; the second track slidably connecting to the first track to enable the protection shield to do the reciprocating movement along the first track.

In one preferred embodiment, the first track of the knife rack body is a ramp and the second track of the protection shield is a sliding trough, the first track of the knife rack body is a sliding trough and the second track of the protection shield is a ramp, and the multispindle machining center further comprises a driving unit connecting between the knife rack body and the protection shield to drive the protection shield to do the linear reciprocating movement between the open position and the closed position.

The multispindle machining center of the present invention has knives being able to be connected with all spindles, which means knives with different size and shape (such as BT, SK, HSK, etc.) can be used in the present invention. By flexibly changing the knife claw and knife claw trough according to the standard of the knife, using more kinds of knives will become possible. Moreover, by connecting knives with different size and shape, the multispindle machining center can do the processing works of different shapes simultaneous, thereby improving the processing efficiency.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an assembled and partially exploded view of the preferred embodiment according to the present invention;

FIG. 2 is a stereoscopic assembly drawing of FIG. 1; FIG. 2 shows the open status of the protection shield;

FIG. 3 is a stereoscopic assembly drawing of FIG. 1; FIG. 3 shows the closed status of the protection shield;

FIG. 4 is a schematic view of the knife arrangement of FIG. 1;

FIG. 5 is a schematic diagram of operation of FIG. 1; FIG. 5 shows the open status of the protection shield;

FIG. 6 is a schematic diagram of operation of FIG. 1; FIG. 6 shows the closed status of the protection shield;

FIG. 7A-7D is a schematic diagram of operation of FIG. 1; FIG. 7A-7D shows the operation when the spindle takes the knife; and

FIG. 8A-8D is a schematic diagram of operation of FIG. 1; FIG. 8A-8D shows the operation when the spindle puts back the knife.

### DETAILED DESCRIPTION

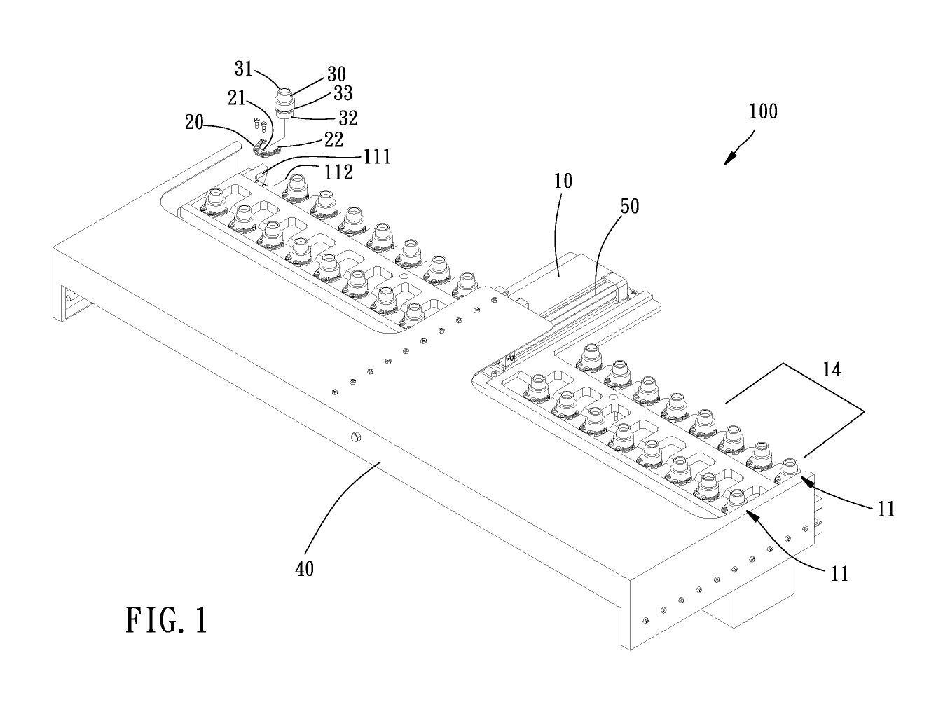

Please refer to FIGS. 1-8, which is a multispindle machining center according to one of the embodiment of the present invention. The multispindle machining center includes a machine body and a knife rack 100 arranged on the machine body.

The multispindle machining center has a plurality of spindles 93, and since the multispindle machining center is a known technology, the figures and explanations of the multispindle machining center will not be shown in the specification. In the present invention, the multispindle machining center has four spindles, but not limited thereto.

The knife rack 100 mainly includes a knife rack body 10, a plurality of knife claws 20, a plurality of knife holders 30, a protection shield 40, and a driving unit 50.

Please refer to FIGS. 1-4, the knife rack body 10 has several rows of accommodating troughs 11. Those rows of the accommodating troughs 11 can be arranged horizontally or in a reverse direction. Each row of accommodating troughs 11 is provided with several sets of accommodating troughs 14. In the present embodiment, each set of accommodating trough 14 has 4 accommodating troughs 111, and each accommodating trough 111 further has an accommodating trough opening 112 connecting to the outside. The number of the accommodating trough 111 of each set of accommodating trough 14 can vary according to the number of the spindle. The number of the spindle in the present embodiment is 4 sets. Both opposite outer side of the knife rack body 10 have a first track 12, respectively, and the first track 12 is a sliding trough. The bottom of the knife rack body 10 has two first track elements 13, and the first track element 13 is a sliding trough.

Please refer to FIGS. 1-4, the knife claw 20 is in U shape and flexible. The knife claw 20 has a knife claw trough 21 penetrating the top and the bottom of the knife claw 20, and a knife claw opening 22 connecting the knife claw trough 21 to the outside. Each knife claw 20 is arranged on the knife rack body 10, and the knife claw trough 21 of each knife claw 20 is corresponding to the position of accommodating trough 111. The knife claw opening 22 is corresponding to the position of accommodating trough opening 112.

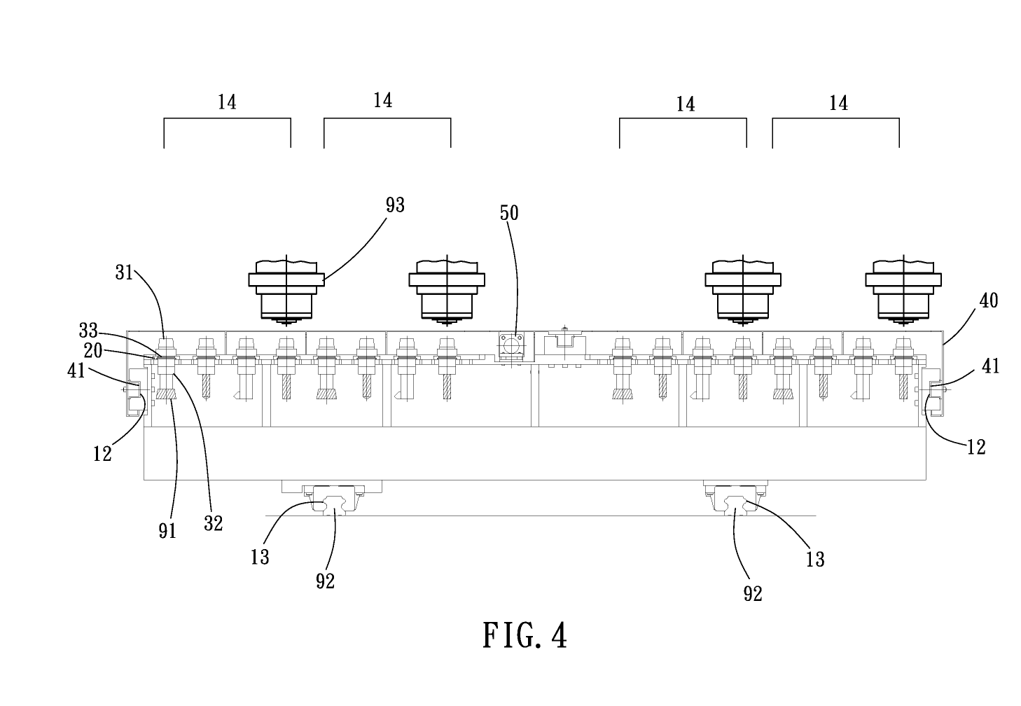

Please refer to FIGS. 1-4, the two opposite terminals of each knife holder 30 have a spindle connecting end 31 and a knife connecting end 32. The shape and size of the spindle connecting ends 31 of each knife holder 30 are all the same, while the size and shape of the knife connecting ends of each knife holder 30 can be the same or not, which depends on the types of the knife. For example, when the size and shape of each knife connecting end 32 is the same, the knife holder 30 can clip those knives with the same shape and size; if not, the knife holder 30 can clip those knives 91 with different shape and size, as shown in FIG. 4. The outer periphery of each knife holder 30 has a clipping portion 33, and the outer periphery of the clipping portion 33 is equal or smaller than the inner periphery of the knife claw 20 and the knife claw trough 21, and the outer periphery of the clipping portion 33 is larger than the inner periphery of the knife claw 20 and the knife claw opening 22. The clipping portion 33 of each knife holder 30 is forced into the knife claw trough 21 of the knife claw 20 via the knife claw opening 22. The claw arm of both sides of the knife claw opening 22 clips each knife holder 30 to temporarily fix each knife holder 30 on each knife claw 20.

Please refer to FIGS. 1-3, the protection shield 40 is located outside of the knife rack body 10, and both opposite inner sides of the protection shield 40 have a second track 41 respectively. The second track 41 is a sliding trough, which is slidably connected to the first track 12 of the knife rack body 10.

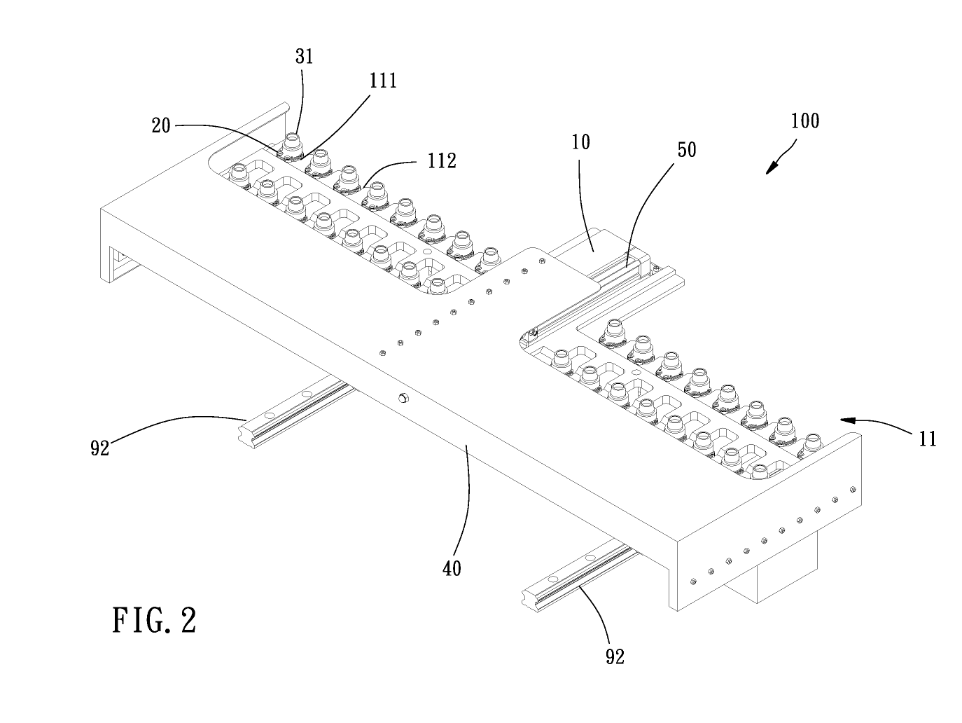

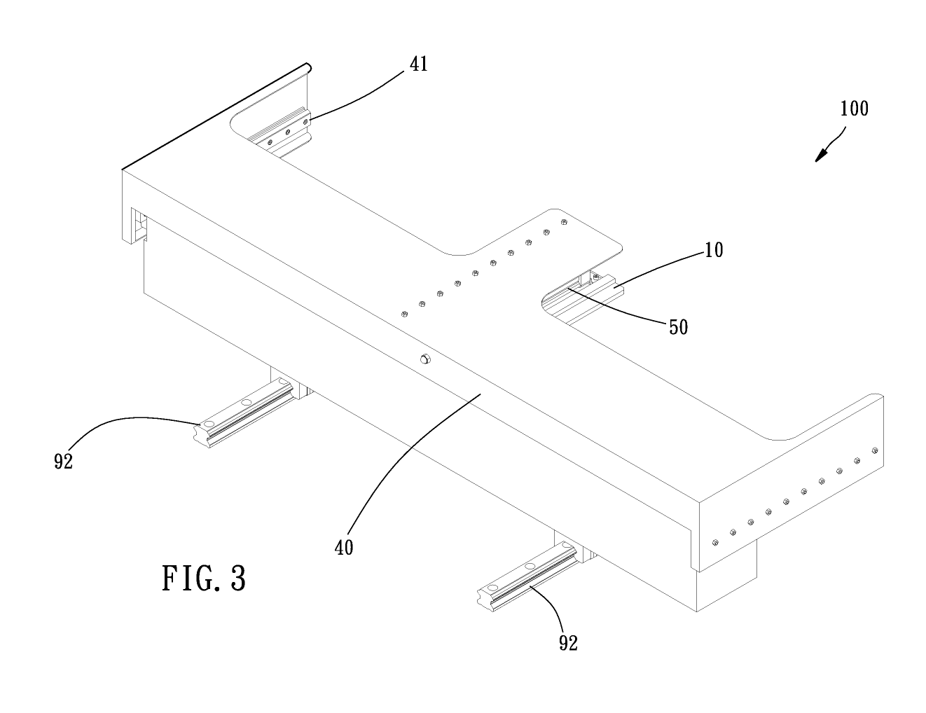

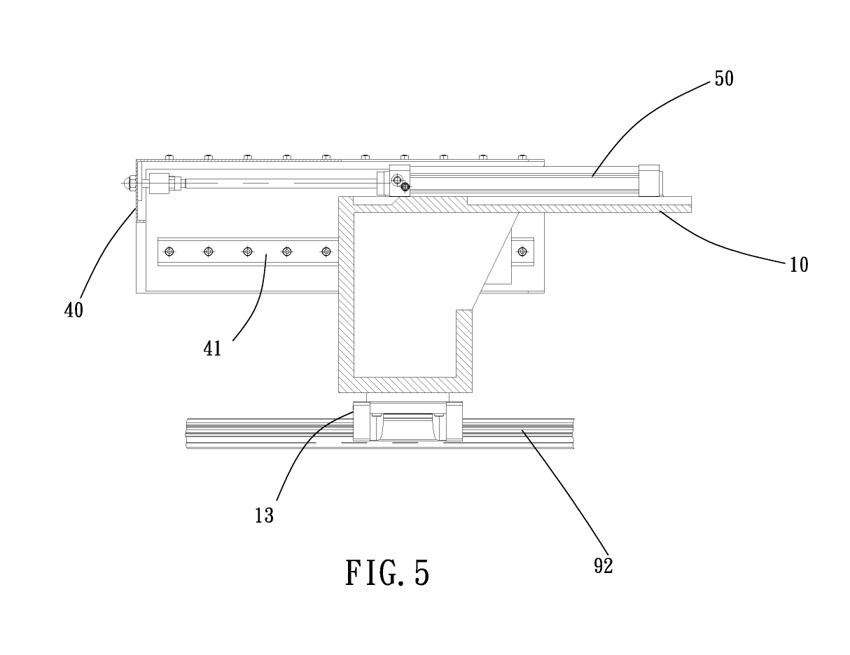

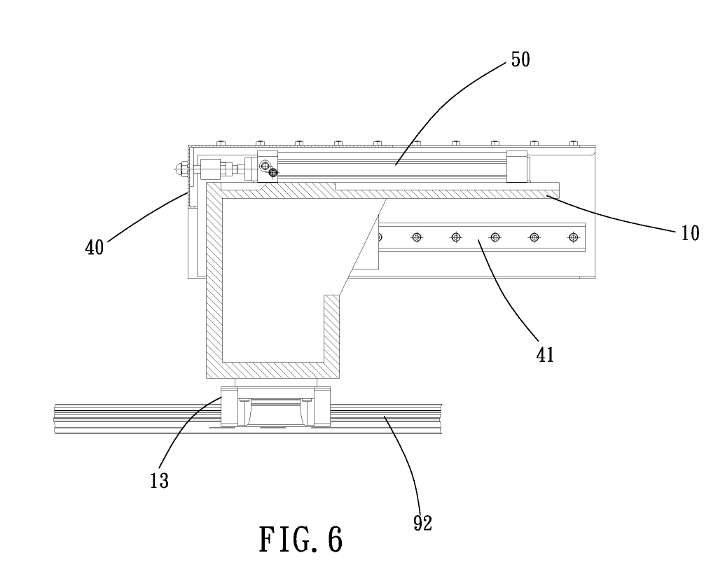

Please refer to FIGS. 1-6, the driving unit 50 is connected between the knife rack body 10 and the protection shield 40, and the driving unit 50 is used to drive the protection shield 40 to do the linear reciprocating movement along the first track 12 of the knife rack body 10. Thus, the protection shield 40 can be driven by the driving unit 50 to do the linear reciprocating movement between the open position and the closed position. When the protection shield 40 is in the open position, all the knife claws 20, knife holders 30, and the knives 91 connected to the knife holders 30 that arranged on the knife rack body are exposed outside the protection shield 40 (as shown in FIGS. 2 and 5); when the protection shield 40 is in the closed position, all the knife claws 20, knife holders 30, and the knives 91 connected to the knife holders 30 that arranged on the knife rack body 10 are covered inside the protection shield 40 (as shown in FIGS. 3 and 6) to prevent the collision and contamination.

The aforementioned is one of the preferred embodiments of the structure and assembling method of the multispindle machining center and their knife rack 100 according to the present invention. The using method is described as follows.

First, the first track element 13 of the knife rack body 100 can be slidably connected to a second track element 92 in the outside (the machine body of the multispindle machining center), which enables the body of the knife rack to do the reciprocating movement along the second track element 92 to facilitate the user to operate and maintain the machine.

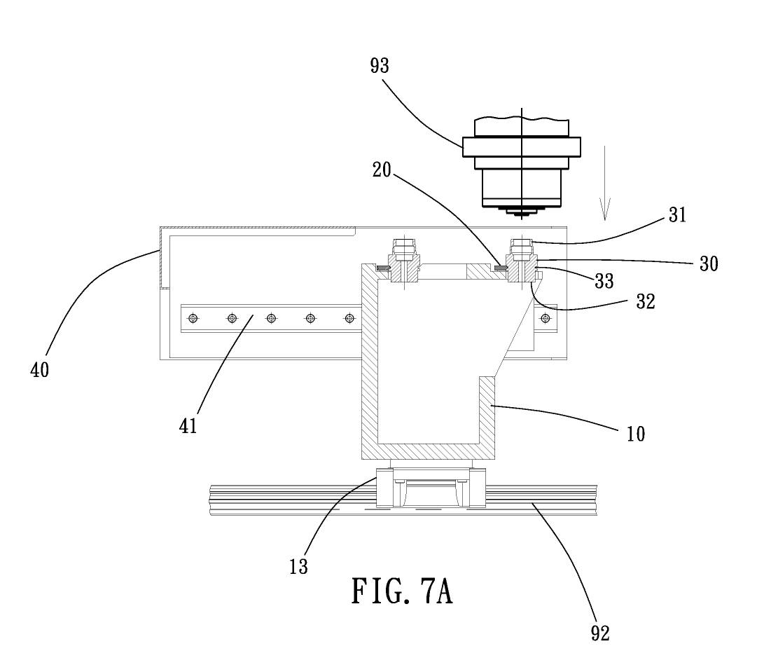

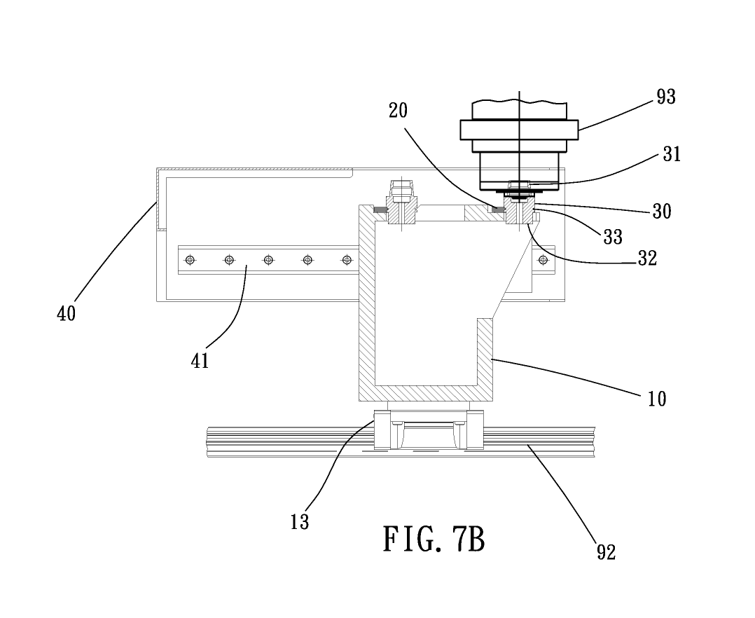

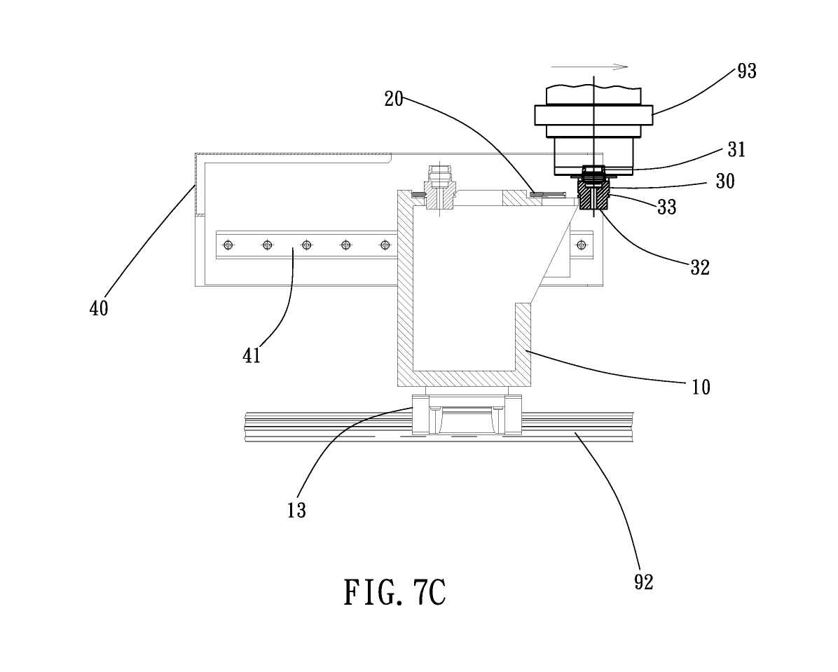

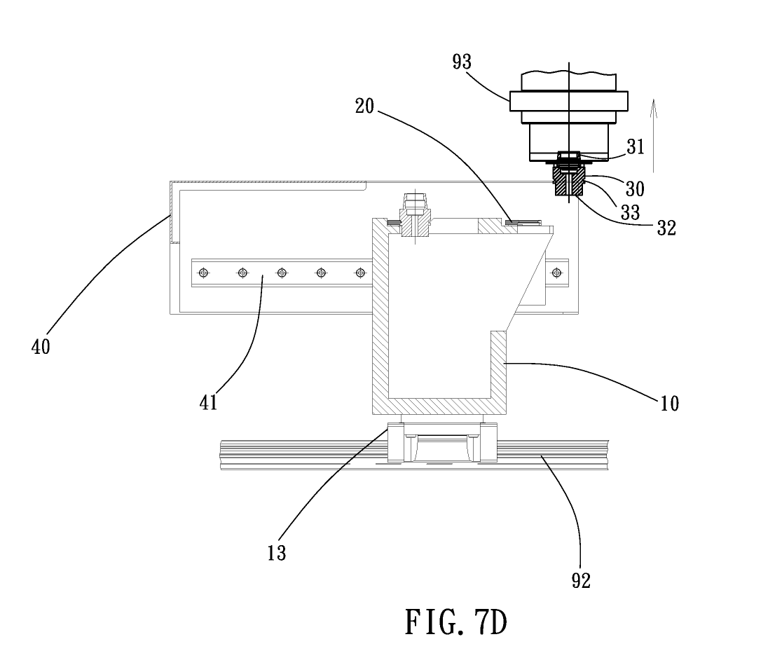

Second, when the spindle 93 of the multispindle machining center wants to take the knife, as shown in FIGS. 7A, 7B, 7C, 7D, the driving unit 50 moves the protection shield 40 to the open position to expose the knife claw 20, knife holder 30, and the knife 91 connected to the knife holder 30 to the outside of the protection shield 40. And then, the spindle 93 can move down to approach the knife holder (as shown in FIG. 7A) of the target knife (not shown in the figures), and keep moving down until connecting to the spindle connecting end 31 of the knife holder 30 (as shown in FIG. 7B). Afterward, the spindle 93 pulls out the connected knife holder 30 along with the knife from the direction of the knife claw opening 22 of the knife claw 20, forcing the knife holder 30 to be moved out from the knife claw opening 22. Thus, the knife holder 30 can be released form the clipping of the knife claw (as shown in FIG. 7C). The knife holder 30 and the knife connected thereon can be moved upward together from the spindle 93 or moved to the position where the work piece needs to be processed (as shown in FIG. 7D), thereby completing the knife taking process.

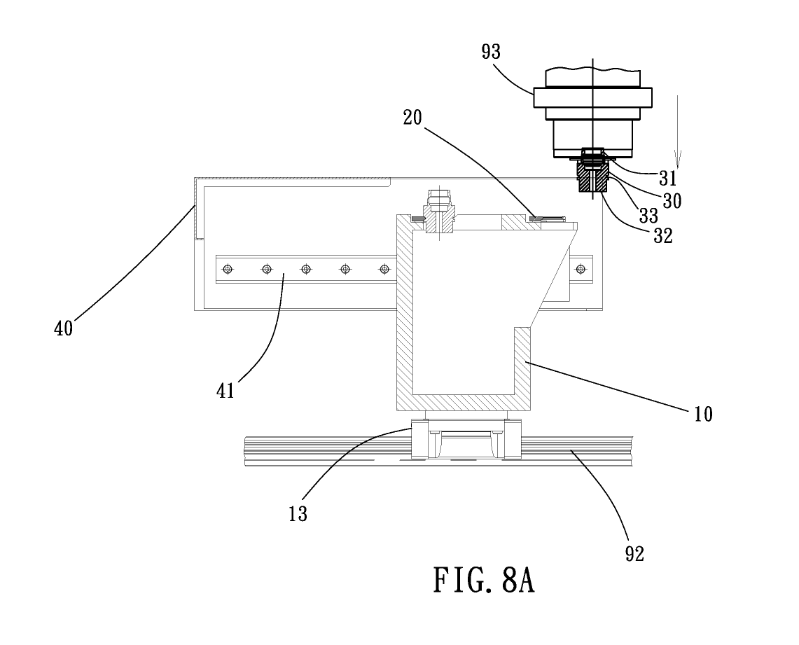

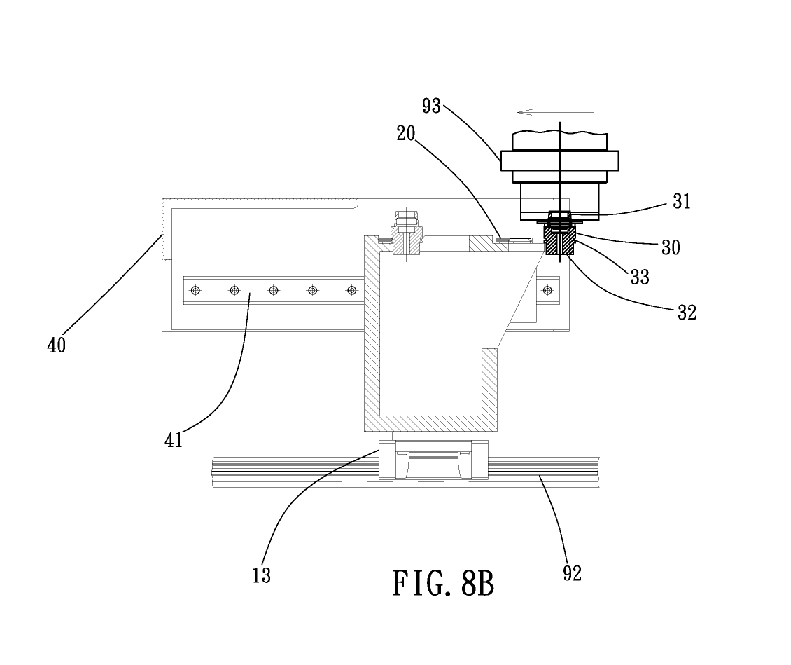

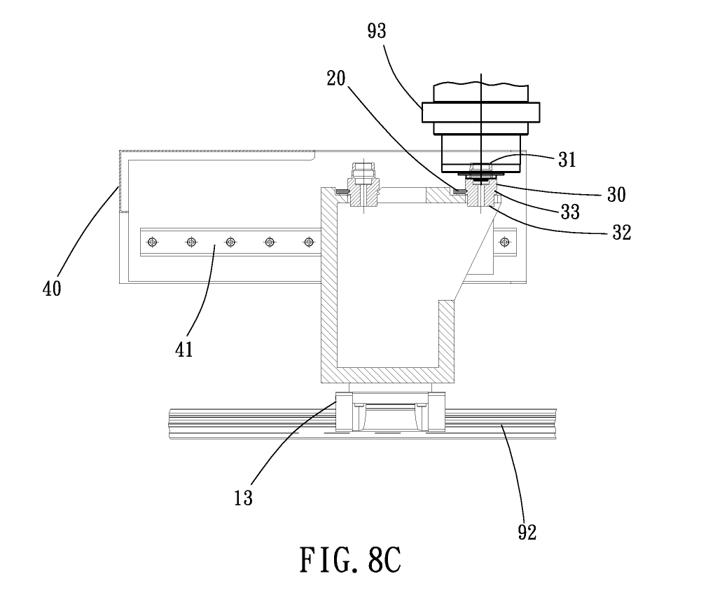

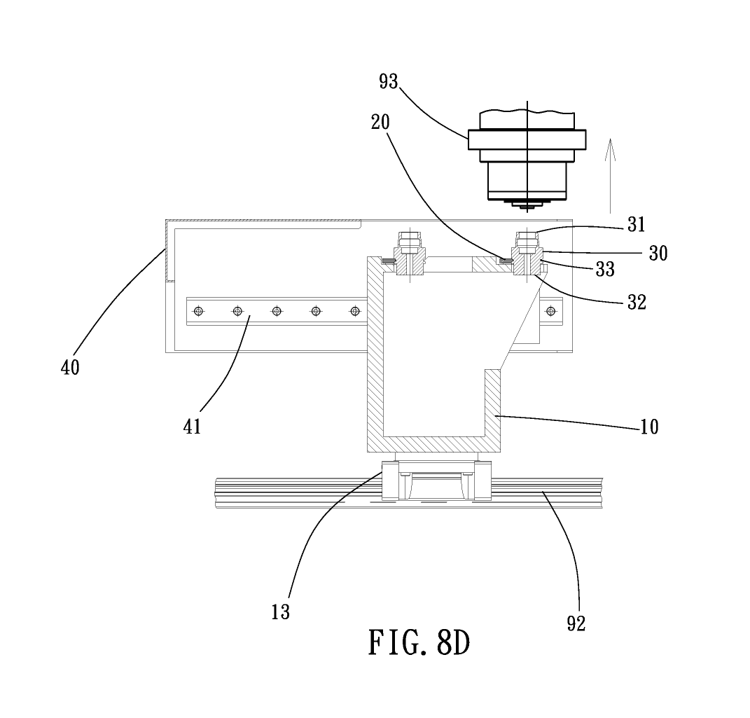

When the spindle 93 of the multispindle machining center wants to put the knife back, as shown in FIGS. 8A, 8B, 8C, 8D (Note: the knife putting back process can be executed when the processing work is done, or before changing to another knife), the driving unit 50 moves the protection shield 40 to the open position to expose the knife claw 20 arranged on the knife rack body 10 to the outside of the protection shield 40. And then, the spindle 93 can move the connected knife holder 30 and the knife (not shown in the figures) connected thereon downward (as shown in FIG. 8A), forcing the clipping portion 33 of the knife holder 30 to move to the same height level as the knife claw opening 22 of the knife claw 20 (as shown in FIG. 8B). The clipping portion 33 of the knife holder 30 then is driven by the spindle 93 and keeps moving horizontally until being forced into the knife claw trough 21 of the knife claw 20 via the knife claw opening 22 (as shown in FIG. 8C). Finally, the spindle 93 will move upward (as shown in FIG. 8D) and back to the original processing position, or moves to the position where another desired taken knife is situated to do another knife-taking process.

Since the multispindle machining center has a plurality of knife holders 30, and each knife holder has the spindle connecting end 31 with the same size and shape, which facilitates the spindle 93 to connect the knife holder 30. On the other hand, each knife holder 30 has the knife connecting end 32 with different same size and shape, which facilitates the knives with different shapes and sizes to be connected with the knife holder 30.

The multispindle machining center with the knife rack 100 of the present invention can use each spindle to connect the knife with different size and shape simultaneously, and makes it possible to do the processing work of different size and shape on work pieces at the same time (such as shaving, milling, drilling, boring, etc.), thereby improving the working efficiency.

Besides, in the previous embodiment, although the first track 12 of the knife rack body 10 is a sliding trough, and the second track 41 of the protection shield 40 is a sliding ramp, however, the first track 12 can also be the sliding ramp and the second track 41 can be the sliding trough, which can achieve the same effect in either arrangement.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A multispindle machining center, comprising:
a machine body;
a plurality of spindles equipped on the machine body; and
a knife rack arranged on the machine body, wherein the knife rack includes:
a knife rack body having at least one row of accommodating trough, the row of the accommodating trough having a plurality of accommodating troughs and a plurality of accommodating trough openings connecting the accommodating trough to the outside;
a plurality of knife claws arranged on the knife rack, the knife claw having a knife claw trough penetrating the top and the bottom of the knife claw, and a knife claw opening connecting the knife claw trough to the outside; every knife claw trough of the knife claw being corresponding to each accommodating trough of the knife rack body, and each knife claw opening of the knife claw being corresponding to each accommodating trough opening of the knife rack body; and
a plurality of knife holder having a spindle connecting end and a knife connecting end on both terminals, respectively; the size and shape of the spindle connecting end of each holder being the same, and the knife connecting end of each knife holder having the same or different size and shape; each knife holder having a clipping portion on the outer periphery, and each clipping portion of the knife holder being forced into the knife claw trough from the knife claw opening in a detachable way.

2. The multispindle machining center according to claim 1, wherein the row of the accommodating trough of the knife rack body has at least one set of accommodating trough, and each set of the accommodating trough has accommodating trough and accommodating trough openings connecting the accommodating troughs to the outside corresponding to the amounts of the spindles.

3. The multispindle machining center according to claim 1, wherein each knife claw is in a U shape and is flexible.

4. The multispindle machining center according to claim 1, wherein the knife connecting end of each knife holder is able to clip the knife with different shape and size.

5. The multispindle machining center according to claim 1, wherein the outer periphery of the clipping portion is smaller than the inner periphery of the knife claw trough of the knife claw, and the outer periphery of the clipping portion is larger than the inner periphery of the knife claw opening of the knife claw.

6. The multispindle machining center according to claim 1, wherein the knife rack further includes a protection shield located outside of the knife rack body, the protection shield can do a linear reciprocating movement between an open position and a closed position; when the protection shield is in the open position, all the knife claws, knife holders, and the knives connected to the knife holders that arranged on the knife rack body are exposed outside the protection shield; when the protection shield is in the closed position, all the knife claws, knife holders, and the knives connected to the knife holders that arranged on the knife rack body are covered inside the protection shield.

7. The multispindle machining center according to claim 1, wherein both opposite sides of the knife rack body have a first track respectively, and the both opposite sides of the protection shield have a second track respectively; the second track slidably connecting to the first track to enable the protection shield to do the reciprocating movement along the first track.

8. The multispindle machining center according to claim 7, wherein the first track of the knife rack body is a ramp and the second track of the protection shield is a sliding trough.

9. The multispindle machining center according to claim 7, wherein the first track of the knife rack body is a sliding trough and the second track of the protection shield is a ramp.

10. The multispindle machining center according to claim 6, wherein the multispindle machining center further comprises a driving unit connecting between the knife rack body and the protection shield to drive the protection shield to do the linear reciprocating movement between the open position and the closed position.
